(19) United States
(12) Patent Application Publication
(10) Pub. No.: US 2012/0036522 A1
(43) Pub. Date: Feb. 9, 2012

(54) TV Shopping System and Method Thereof

(76) Inventor: Chien-Fa Wang, Sindian (TW)

(21) Appl. No.: 12/875,180

(22) Filed: Sep. 3, 2010

(30) Foreign Application Priority Data
Aug. 6, 2010 (TW) 099126265

(51) Int. Cl. H04N 7/16; G06F 3/00

(52) U.S. Cl. 725/5; 725/60

(57) ABSTRACT

A TV shopping system has a shopping service platform gathering and classifying channel information and consumption information for a network device connected with the shopping service platform to download through the Internet and transmit to a TV remote control. The network device can receive shopping information uploaded from the TV remote control and entered by a user and transmit the shopping information to the shopping service platform. The TV remote control has an input module for users to select a command transmitted to the network device. Given the TV shopping system, the shopping service platform can interact with the TV remote control through the network device. Users transmits the shopping information through the TV remote control, the network device to the shopping service platform, and purchases merchandise exhibited on a TV commercial or directly promoted by a shopping channel through the shopping service platform.

### BACKGROUND OF THE INVENTION

1. Field of the Invention

The present invention relates to a shopping system, and more particularly to a TV shopping system and method thereof.

2. Description of the Related Art

With high penetration rate of cable TV, TV shopping emerges as a new way allowing consumers to conveniently purchase desired merchandise without going out to the store carrying the merchandise. Such convenience gradually affects the way of shopping. However, existing TV shopping channels can only display information of merchandise on the screen. Having simple function like that, TV shopping still has the following drawbacks:

1. If intending to purchase merchandise from a TV shopping channel, consumer must record information of merchandise, such as product name, product code, price and the like, before calling the TV shopping channel operator to place an order. Besides, due to limited phone lines for inquiring and ordering, the lines provided for TV shopping are always busy, and consumers usually need to hold on the line or dial several times before the line can really go through. Hence, the overall ordering process is inconvenient and time-consuming.

2. If recording merchandise related information, such as product code, size and the like, incorrectly, consumers may wind up unexpectedly receiving wrong merchandise to be returned or exchanged. The whole process in compensating minor mistake inadvertently made is full of surprise and frustrating.

3. Consumers can only buy the merchandise promoted through TV shopping channels. When intending to buy merchandise appearing on a TV commercial, consumers still need to personally go to the store carrying the merchandise to buy the merchandise.

### SUMMARY OF THE INVENTION

A first objective of the present invention is to provide a TV shopping system and method thereof allowing users to purchase merchandise promoted through a TV commercial or directly through a TV shopping channel.

To achieve the foregoing objective, the TV shopping system has a shopping service platform, a network device and a TV remote control.

The shopping service platform has a channel information mapping table and a plurality of program lists. The channel information mapping table has existing cable TV channels, cable TV operators and channel numbers respectively corresponding to the cable TV channels of the cable TV operators. The program list is associated with each cable TV channel. The shopping service platform generates and outputs channel information and consumption information in accordance with an information download request.

A network device is connected with the shopping service platform through the Internet to transmit the information download request to the shopping service platform and receive the channel information and the consumption information corresponding to the information download request.

The TV remote control has a remote control unit, a display unit, a data processing and transaction unit and a power supply unit.

The remote control unit remotely controls a television. The data processing and transaction unit is wirelessly connected to the network device, is electrically connected with the display unit, receives an information download signal for downloading the channel information and the consumption information of a cable TV channel, generates and transmits the information download request to the network device through the Internet to acquire the corresponding channel information and consumption information, displays the corresponding channel information and consumption information on the display unit, and generates shopping information and transmits the shopping information to the shopping service platform through the network device for the shopping service platform to receive a transaction request generated by the remote control unit and then complete a transaction. The power supply unit supplies an operating power to each one of the foregoing units of the TV remote control.

A second objective of the present invention is to provide a TV shopping method allowing users to purchase merchandise promoted through a TV commercial or directly through a TV shopping channel.

To achieve the foregoing objective, the TV shopping method has steps of:

providing a shopping service platform having a channel information mapping table, a plurality of program lists, an information download processing step and a transaction request processing step, in which a channel information mapping table has existing cable TV channels, cable TV operators and channel numbers respectively corresponding to the cable TV channels of the cable TV operators, and each program list is associated with each cable TV channel;

providing a network device connected with the shopping service platform through the Internet to transmit an information download request to the shopping service platform and receiving channel information and consumption information corresponding to the information download request; and

providing TV remote control linked with the network device, remotely controlling a television and providing a step of downloading merchandise information on a real-time basis and a step of purchasing merchandise associated with a TV commercial.

When performing the step of downloading merchandise information on a real-time basis, the TV remote control transmits the information download request to the shopping service platform to activate the information download processing step of the shopping service platform, and transmits the channel information mapping table, the program list associated with each cable TV channel, and consumption information associated with merchandise of TV commercials of each cable TV channel to the TV remote control through the network device.

When performing a step of purchasing merchandise associated with a TV commercial, the TV remote control transmits shopping information to the shopping service platform to activate the transaction request processing step of the shopping service platform to place an order to a corresponding merchandise vendor and transmit a delivery completion notice to the TV remote control through the network device after completion of the delivery.

The shopping service platform gathers and classifies the program lists of each cable TV channel to acquire information of merchandise available for sale directly through a shopping channel and TV commercial advertised through the channel. In collaboration with the household network device and TV remote control, the shopping service platform transmits the merchandise information to the TV remote control through the network device. Consumers simply need to confirm the merchandise information displayed on the TV remote control and issue a transaction request through the TV remote control, the network device to the shopping service platform. The shopping service platform further authenticates the transaction request with a corresponding bank and then places an order to a vendor of the merchandise. When watching a TV commercial or a TV shopping channel, instead of memorizing the merchandise information, consumers can place an order to purchase desired merchandise by just pressing corresponding buttons on the TV remote control. Accordingly, the TV shopping system and method thereof address a more convenient and selective way in TV shopping.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a TV shopping system in accordance with the present invention;

FIG. 2 is an operating flow chart of a shopping service platform of the TV shopping system in FIG. 1;

FIG. 3 is an operating flow chart of a network device of the TV shopping system in FIG. 1;

FIG. 4 is an operating flow chart of a TV remote control of the TV shopping system in FIG. 1;

FIG. 5 is a front plan view of a TV remote control of the TV shopping system in FIG. 1 for illustrating a display mode in displaying consumption information;

FIG. 6 is a front plan view of the TV remote control in FIG. 5 for illustrating a display mode in selecting type of payment;

FIG. 7 is a front plan view of the TV remote control in FIG. 5 for illustrating a display mode in choosing a type of payment;

FIG. 8 is a front plan view of the TV remote control in FIG. 5 for illustrating a display mode in charging with a credit card;

FIG. 9 is a front plan view of the TV remote control in FIG. 5 for illustrating a display mode in confirming a transaction through the use of a credit card;

FIG. 10 is a front plan view of the TV remote control in FIG. 5 for illustrating a display mode in completing the transaction and generating transaction related information;

FIG. 11 is a flow chart of the TV shopping system in FIG. 1 for illustrating procedures in displaying consumption information;

FIG. 12 is a flow chart of the TV shopping system in FIG. 1 for illustrating procedures of using a remote control of the TV shopping system for TV shopping;

FIG. 13 is a front plan view of a remote control of a second embodiment of a TV shopping system in accordance with the present invention for illustrating a display mode in confirming a transaction through the use of a credit card;

FIG. 14 is a front plan view of the remote control in FIG. 13 for illustrating a display mode in choosing a type of payment; and

FIG. 15 is a front plan view of the remote control in FIG. 13 for illustrating a display mode in confirming a transaction through the use of a credit card.

### DETAILED DESCRIPTION OF THE INVENTION

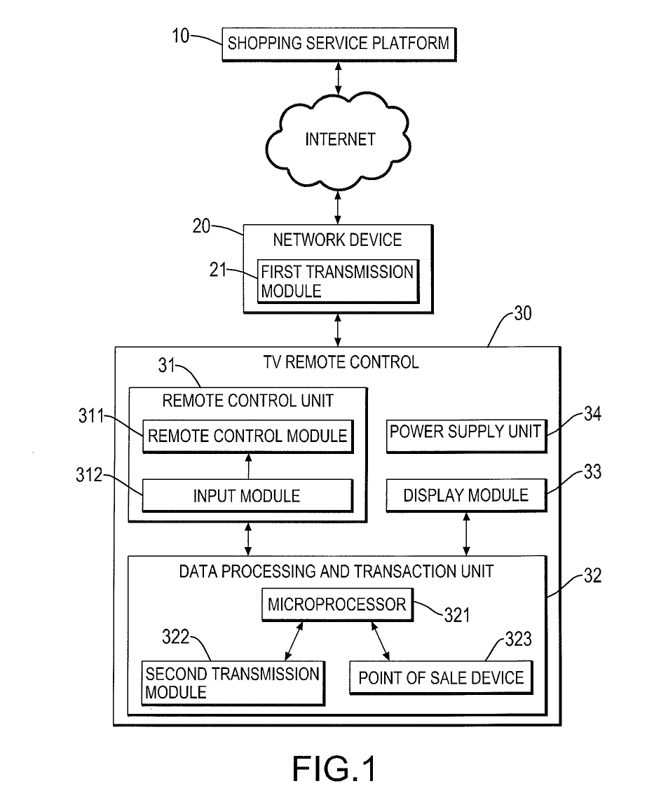

With reference to FIG. 1, a first embodiment of a TV shopping system has a shopping service platform 10, a network device 20 and a TV remote control 30.

The shopping service platform 10 is built in a remote server and is linked with servers of TV shopping channel operators, vendors selling merchandise through TV commercials, banks and a credit card center for secure transactions. The shopping service platform 10 has a channel information mapping table and a plurality of program lists. Each program list is associated with each cable TV channel, and generates and outputs channel information and consumption information in accordance with an information download request.

The network device 20 is connected with the shopping service platform 10 through the Internet to transmit the information download request to the shopping service platform 10 and receives the channel information and the consumption information corresponding to the information download request. The network device 20 may be a computer, a router or a network bridge. The network device 20 has a first transmission module 21. The first transmission module 21 may be a wireline transmission module, such as a USB port, or a wireless transmission module, such as a RF transmitter or a bluetooth transmitter.

The TV remote control 30 integrates all functions of existing TV remote control therein and has a remote control unit 31, a display unit 33, a data processing and transaction unit 32 and a power supply unit 34.

The remote control unit 31 serves to remotely control basic remote control functions of a television, such as channel switching, volume adjustment and the like, and has an input module 312 and a remote control module 311. The input module 312 has TV remote control buttons 313, channel classification buttons 314 and TV shopping 315. The remote control module 311 is electrically connected with the input module 312 and generates different remote control commands to achieve the purpose of TV remote control in accordance with the buttons of the input module 312 pressed for TV remote control and channel classification.

The display unit 33 is a touch panel having a display function and an input function. The input function of the display unit 33 may replace the TV shopping buttons of the input module 312.

The data processing and transaction unit 32 is wirelessly connected with the network device 20, is electrically connected with the display unit 33 and the remote control unit 31, and has a microprocessor 321, a second transmission module 322 and a point of sale device 323. The microprocessor 321 serves as an arithmetic and control center. The second transmission module 322 is electrically connected with the microprocessor 321 and may be a wireline transmission module, such as a USB port, or a wireless transmission module, such as a RF transmitter or a bluetooth transmitter, in connection with the first transmission module 322 being a same type of wireline transmission module or wireless transmission module. The point of sale device 323 is electrically connected with the microprocessor 321 and can read information in credit card, debit card or store value card for payment. Given credit card as an example in the present embodiment, after reading a credit card, the point of sale device 323 generates a payment information and transmits it to the microprocessor 321.

The power supply unit 34 serves to supply an operating power to each one of the rest of units of the TV remote control. In the present embodiment, the power supply unit 34 has a charging circuit and a rechargeable battery. The rechargeable battery is connected with the second transmission module 322 through the charging circuit. When the TV remote control 30 is electrically connected with the network device 20, the network device charges the rechargeable battery through the charging circuit besides transmitting data. When the TV remote control 30 is not electrically connected with the network device 20, a charger having a USB interface can be employed to perform charging.

When receiving an information download signal for downloading the channel information and the consumption information of a specific channel from the input module 312, the microprocessor 321, the microprocessor 321 further generates and transmits the information download request to the first transmission module 21 of the network device 20 through the second transmission module 322. The network device 20 then transmits the information download request to the shopping service platform 10. After receiving corresponding channel information and consumption information, the network device 20 further transmits the channel and consumption information back to the second transmission module 322. The microprocessor 321 drives the display unit 33 to display the channel and consumption information.

When intending to buy merchandise displayed on a TV commercial of a specific channel or sold directly through the channel, a user can press down corresponding TV shopping buttons of the input module 312. The microprocessor 321 receives a transaction request generated by the input module 312 and generates corresponding shopping information including consumption information and payment information. The network device 20 further transmits the shopping information to the shopping service platform 10 through the Internet. The shopping service platform 10 completes the transaction and finishes payment request procedures with respect to a corresponding bank.

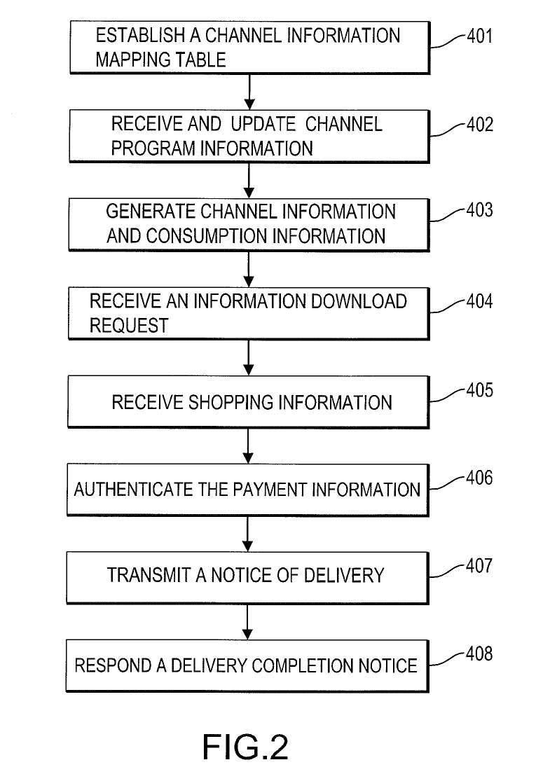

With reference to FIG. 2, the shopping service platform 10 executes steps of:

establishing a channel information mapping table 401; the channel information mapping table has existing cable TV channels, cable TV operators and channel numbers; the channel numbers correspond to the existing cable TV channels of each cable TV operator; although cable TV channel numbers are fixed, some cable TV operators occasionally change some of the cable TV channel numbers in play; therefore, a same program may be broadcasted from different channel numbers of different cable TV operators; in other words, a TV remote control may not select a same program when an identical channel number is selected in the regions broadcasted by different cable TV operators; hence, the channel information mainly targeting at channel selection must consider this variable and provides adaptation to the variation of channel numbers associated with local cable TV operators;

receiving and updating channel program information 402; the shopping service platform 10 acquires a program list in a period of time for each cable TV channel via the Internet or other media;

generating channel information and consumption information 403; step 403 generates the channel information and consumption information in accordance with the received channel program information and the channel information mapping table; the channel information has a channel classification list for each cable TV operator and a plurality of channel options; each channel option has a plurality of play items (programs); each play item has program related information and is downloaded to the TV remote control 30 for users to further perform channel management in the TV remote control 30; the channel classification list is used to classify the channels in the aforementioned channel list; types of channel are classified as: foreign movie, local movie, knowledge, finance and economics, news, sports, children, variety, wireless, Japan, shopping and others; each type has a plurality of channel of identical type; when the channel classification list is downloaded to the TV remote control 30, all the channels of the cable TV operator are classified as groups and displayed on the TV remote control 30 for selection; the channel information and the consumption information is downloaded to the TV remote control 30 for users to further perform channel management and generate consumer behavior through the TV remote control 30;

receiving an information download request 404; after establishing a link with the network device 20, the shopping service platform 10 transmits the channel information and the consumption information to the network device 20 in accordance with the download request transmitted from the network device 30;

receiving shopping information 405; the shopping service platform receives shopping information transmitted from the network device 20 through the Internet; the shopping information has merchandise information and payment information. The merchandise information relates to information associated with merchandise to be purchased by a consumer; the payment information is used to ensure if the consumer has paid through the use of credit card;

authenticating the payment information 406; the shopping service platform transmits the payment information through the Internet to the credit card center to ask for an authorization code;

transmitting a notice of delivery 407; after receiving the authorization code sent from the credit card center through the Internet, the shopping service platform generates delivery information, a reply of accepted use of credit card and a payment notice, and sends the delivery information to a vendor to inform the vendor to deliver, the reply of accepted use of credit card to the network device 20 and the payment notice to a bank to remit payment through the bank; and

responding a delivery completion notice 408; after receiving the delivery completion notice from the vendor through the Internet, the shopping service platform 10 transmits it to the network device 20; the delivery completion notice contains vendor's name, date of delivery and the like.

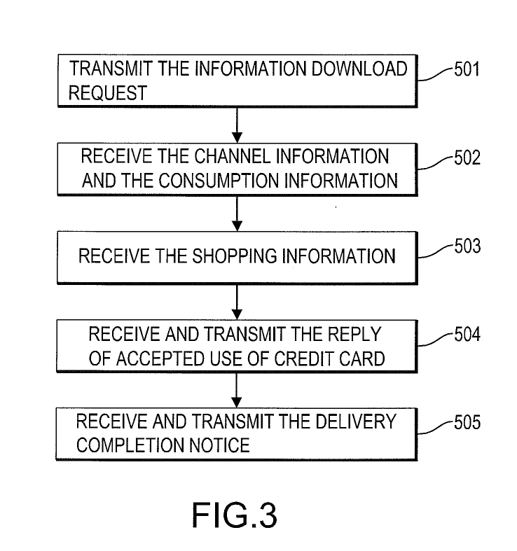

With reference to FIG. 3, the network device executes steps of:

transmitting the information download request 501; the network device 20 receives the information download request sent from the second transmission module 322 and transmits it to the shopping service platform 10 through the Internet;

receiving the channel information and the consumption information 502; the network device 20 receives the channel information and the consumption information sent from the shopping service platform 10 and transmits the channel information and the consumption information to the TV remote control 30 through the first transmission module 21;

receiving the shopping information 503; the first transmission module 21 of the network device 20 receives the shopping information sent from the second transmission module 322 of the TV remote control 30 and transmits the shopping information to the shopping service platform 10 through the Internet;

receiving and transmitting the reply of accepted use of credit card 504; the network device 20 receives the reply of accepted use of credit card sent from the shopping service platform 10 through the Internet and transmits the reply of accepted use of credit card to the TV remote control 30 through the first transmission module 21; and

receiving and transmitting the delivery completion notice 505; the network device 20 receives the delivery completion notice sent from the shopping service platform and transmits the delivery completion notice to the TV remote control 30 through the first transmission module 21.

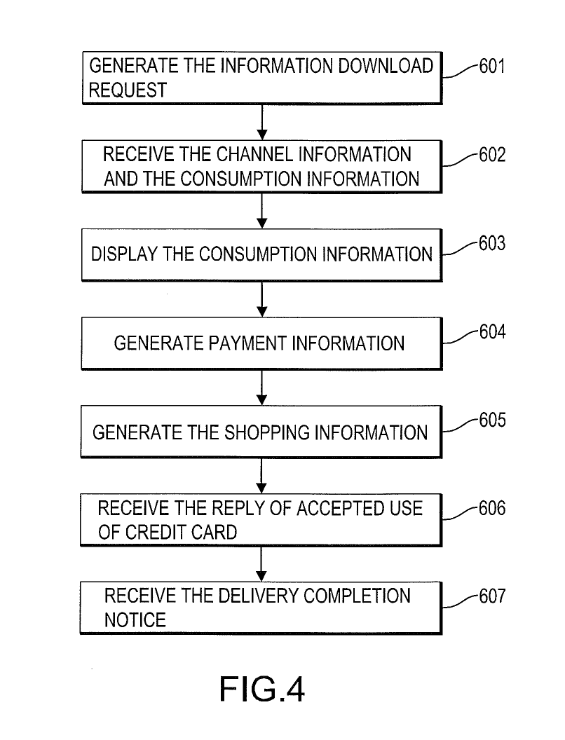

With reference to FIG. 4, the TV remote control executes steps of:

generating the information download request 601; the TV remote control generates the information download request in accordance with a command inputted through the input module 312 by a consumer, and transmits the information download request to the network device 20 through the second transmission module 322;

receiving the channel information and the consumption information 602; the second transmission module of the TV remote control 30 receives the channel information and the consumption information sent from the first transmission module 21 of the network device 20;

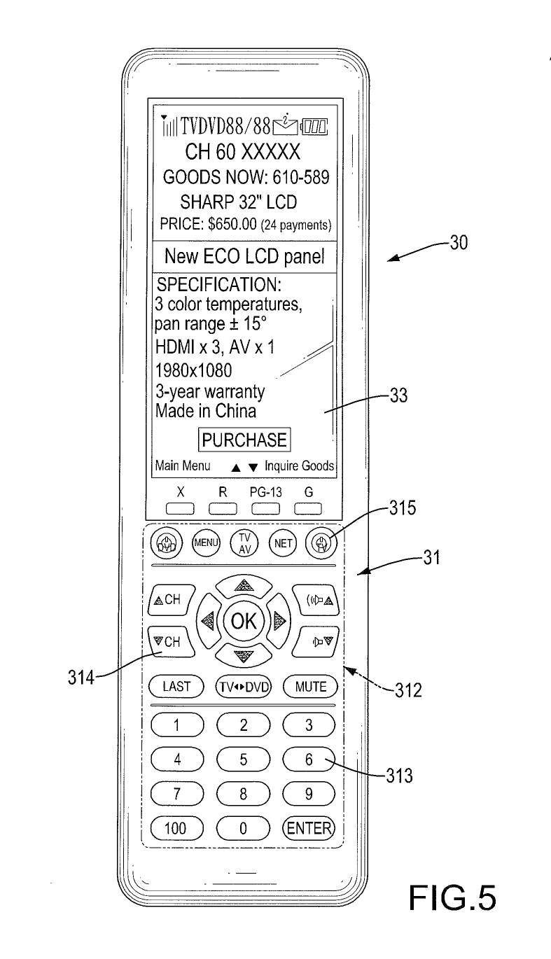

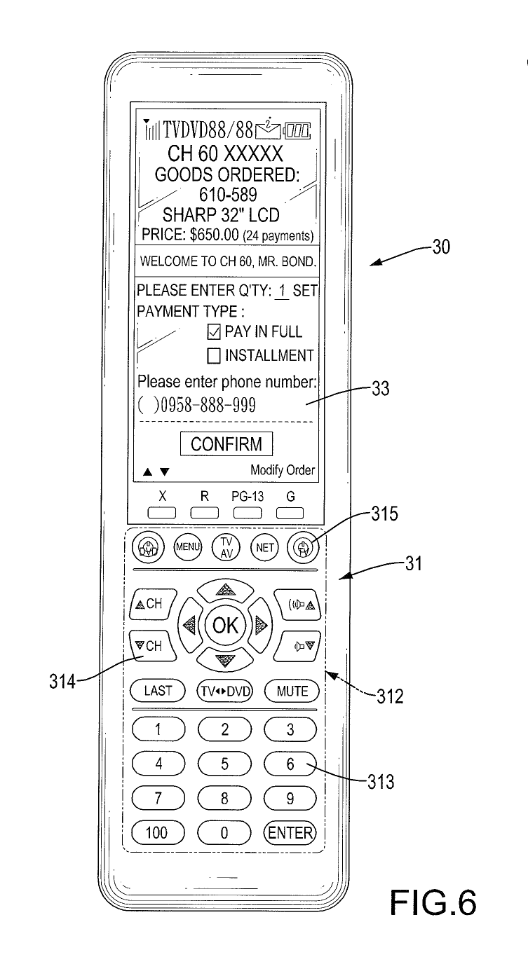

displaying the consumption information 603; with reference to FIG. 5, after a consumer selects a channel through the TV remote control 30, if the channel is a shopping channel or is broadcasting a TV commercial, the display unit 33 displays information associated with specification, price and the like of merchandise currently demonstrated on the TV and a purchase button for the consumer to purchase the merchandise; with reference to FIG. 6, if the consumer enters a transaction request to the input module 312 or the display unit 33, the display unit displays the merchandise information and choices of type of payment on the display unit and proceeds a next step;

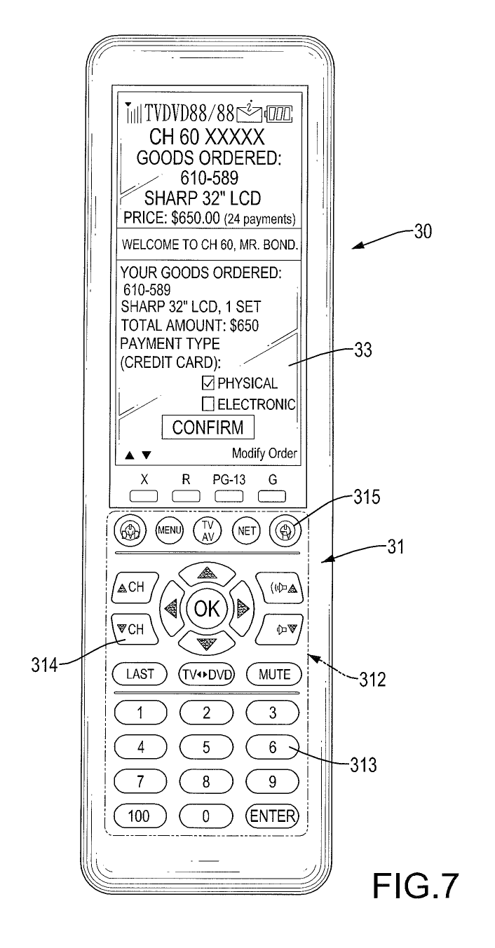

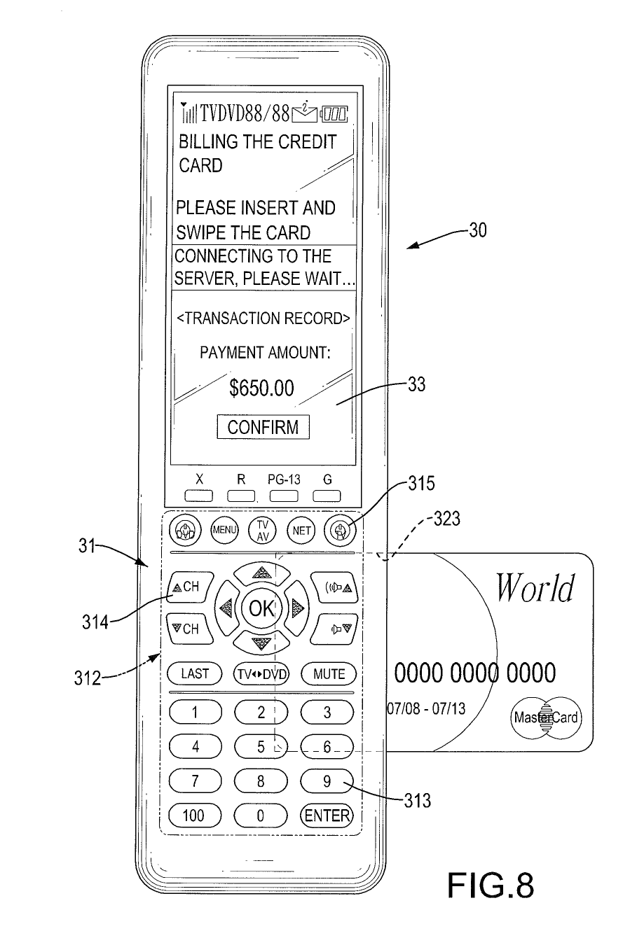

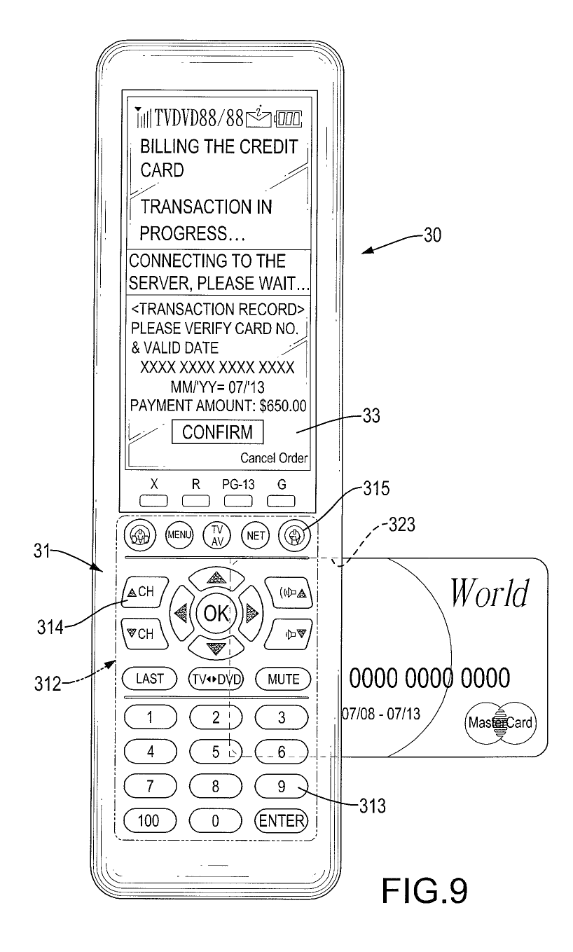

generating payment information 604; with reference to FIG. 7, after the consumer selects a type of payment and confirms that again, with reference to FIGS. 8 and 9, the point of sale device 323 receives order information transmitted form the microprocessor 321 and charges the consumer with the use of a credit card; after the use of the credit card is accepted, the point of sale device 323 generates the payment information and transmit it back to the microprocessor 321;

generating the shopping information 605; after receiving the payment information, the microprocessor 321 integrates the merchandise information and the payment information into the shopping information and transmits the shopping information to the network device 20 through the second transmission module 322;

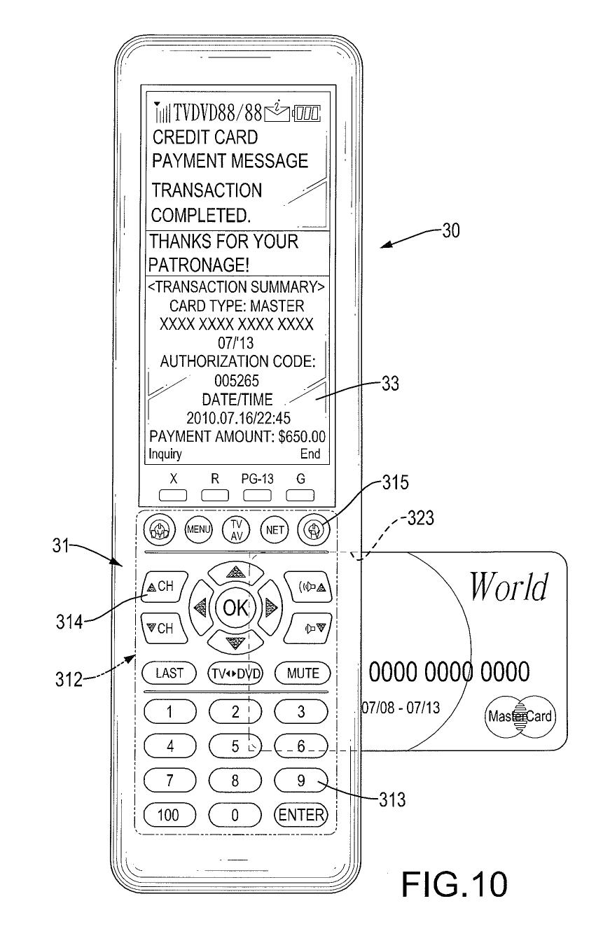

receiving the reply of accepted use of credit card 606; with reference to FIG. 10, the TV remote control 30 receives the reply of accepted use of credit card transmitted from the network device 20 and displays the reply on the display unit 33; and

receiving the delivery completion notice 607; the second transmission module 322 of the TV remote control 30 receives the delivery completion notice transmitted from the first transmission module 21 of the network device 20.

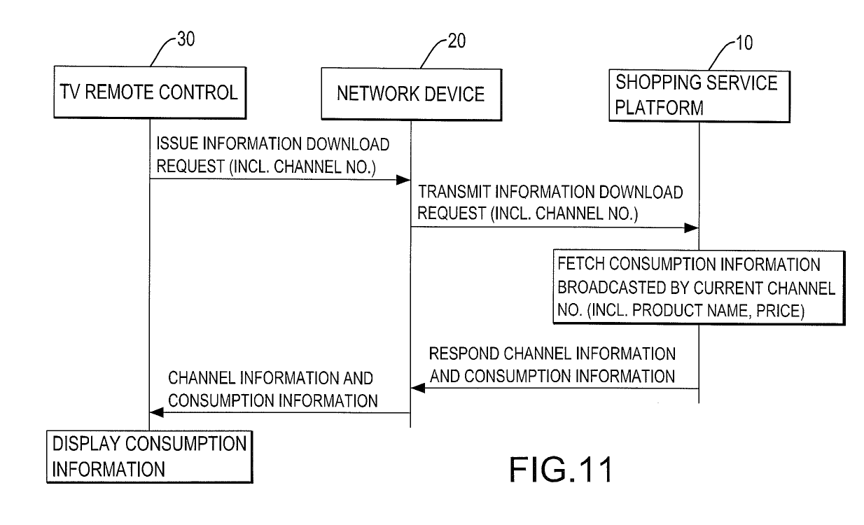

With reference to FIG. 11, when the TV remote control 30 executes a step of downloading merchandise information on a TV commercial on a real-time basis, a consumer first selects a cable TV operator providing services to local subscribers. After confirming the cable TV operator, the consumer transmits an information download request to the shopping service platform 10 through the network device 20 to activate the information download processing step of the shopping service platform 10. The channel information mapping table and the program list associated with each cable TV channel and the channel in the information download request, together with the consumption information of the merchandise on the TV commercial are transmitted to the TV remote control 30 through the network device 20.

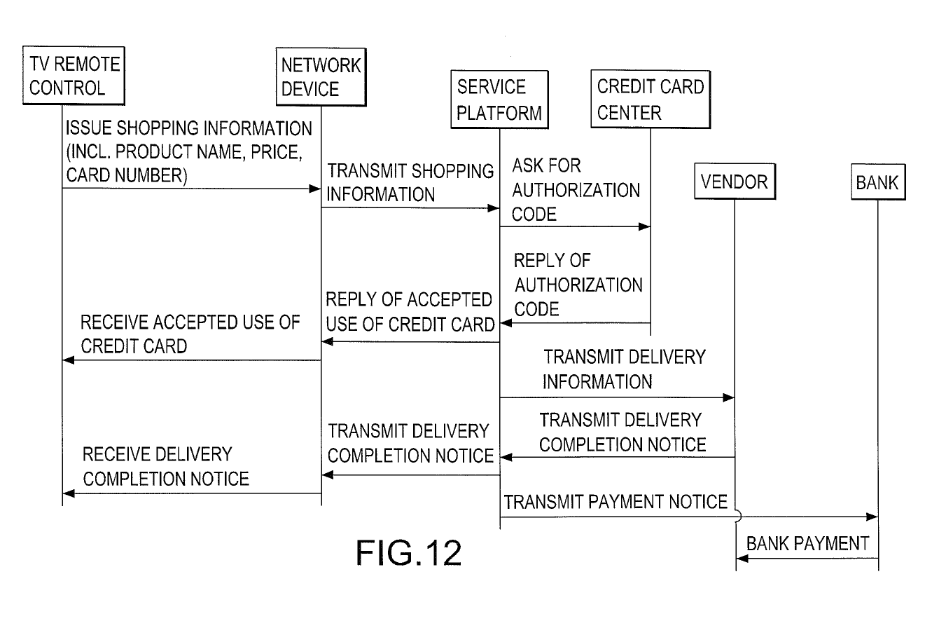

With reference to FIG. 12, when performing a step of purchasing merchandise of a TV commercial, the TV remote control 30 transmits the shopping information to the shopping service platform 10 through the network device 20 to activate the step of purchasing merchandise of a TV commercial, place an order to the merchandise vendor, and transmit the delivery completion notice to the TV remote control 30 through the network device 20 after the completion of delivery.

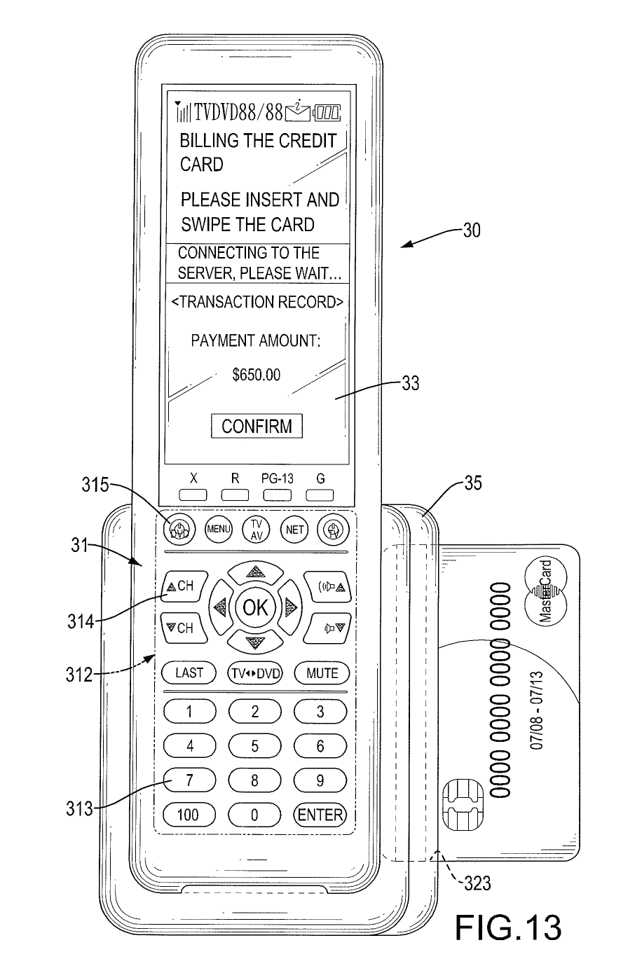

With reference to FIG. 13, a second embodiment of a TV shopping system and method thereof in accordance with the present invention are by and large similar to those of the first embodiment except that the point of sale device 323 is integrated with a charging seat 35 of the TV remote control 30 and is connected with the TV remote control 30 through a common communication interface, such as a USB interface.

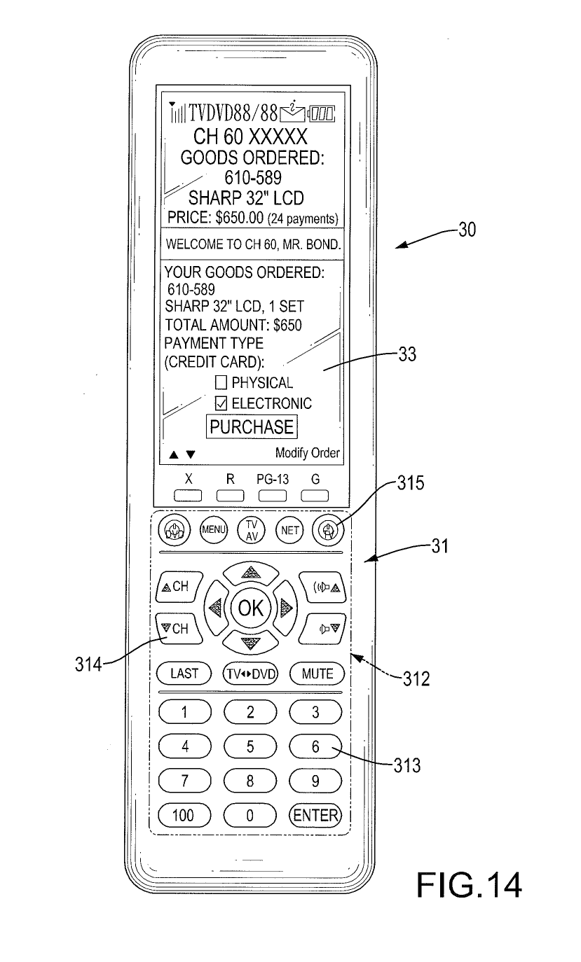

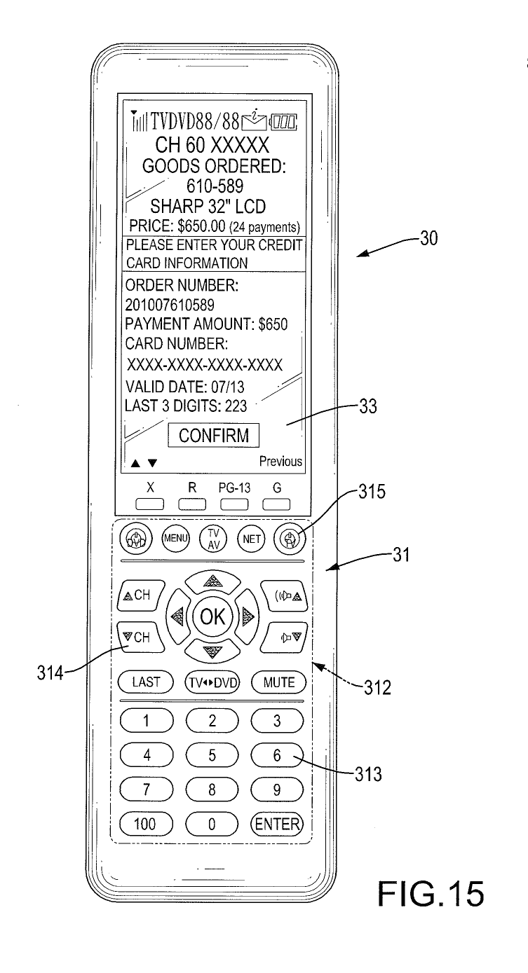

With reference to FIGS. 14 and 15, a third embodiment of a TV shopping system and method thereof in accordance with the present invention are by and large similar to those of the first embodiment except that credit card electronic transaction is also supported in addition to the regular credit card transaction. In the step of generating payment information 604, consumers can input a card number and information associated with a credit card to generate the payment information to replace the need of substantially inserting the credit card into the point of sale device.

Given the TV shopping system and method thereof, consumer can input the shopping information to purchase merchandise through the TV remote control 30 upon watching a TV screen, thereby significantly simplifying TV shopping procedures and preventing from buying wrong merchandise due to consumer's mistake. Instead of being limited to those selling through shopping channel operator, merchandise available to be purchased by the present invention also includes merchandise in TV commercials, making the purchase more convenient and selective.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A TV shopping system, comprising:
a shopping service platform having:
a channel information mapping table having existing cable TV channels, cable TV operators and channel numbers respectively corresponding to the cable TV channels of the cable TV operators; and
a plurality of program lists, each associated with each cable TV channel,
and generating and outputting channel information and consumption information in accordance with an information download request;
a network device connected with the shopping service platform through the Internet to transmit the information download request to the shopping service platform and receiving the channel information and the consumption information corresponding to the information download request; and
a TV remote control having:
a remote control unit remotely controlling a television;
a display unit;
a data processing and transaction unit wirelessly connected to the network device, electrically connected with the display unit, receiving an information download signal for downloading the channel information and the consumption information of a cable TV channel, generating and transmitting the information download request to the network device through the Internet to acquire the corresponding channel information and consumption information, displaying the corresponding channel information and consumption information on the display unit, and generating a shopping information and transmitting the shopping information to the shopping service platform through the network device for the shopping service platform to receive a transaction request generated by the remote control unit and then complete a transaction; and
a power supply unit supplying an operating power to each one of the rest of units of the TV remote control.

2. The TV shopping system as claimed in claim 1, wherein
the network device has a first transmission module;
the data processing and transaction unit of the TV remote control has:
a microprocessor serving as an arithmetic and control center; and
a second transmission module electrically connected with the microprocessor and linked with the first transmission module;
the remote control unit of the TV remote control has:
a remote control module electrically connected with the microprocessor; and
an input module electrically connected with the microprocessor and having buttons respectively for TV remote control, channel classification and TV shopping.

3. The TV shopping system as claimed in claim 1, wherein the shopping information has merchandise information and payment information.

4. The TV shopping system as claimed in claim 2, wherein the shopping information has merchandise information and payment information.

5. The TV shopping system as claimed in claim 1, wherein
the data processing and transaction unit further has a point of sale device electrically connected with the microprocessor to read a card for payment and generate and transmit the payment information to the microprocessor, and
the shopping service platform is linked with servers of a credit card center and banks for secure transactions, and completes the transaction and finishes payment request procedures with respect to a corresponding bank after generating the payment information.

6. The TV shopping system as claimed in claim 2, wherein
the data processing and transaction unit further has a point of sale device electrically connected with the microprocessor to read a card for payment and generate and transmit the payment information to the microprocessor, and
the shopping service platform is linked with servers of a credit card center and banks for secure transactions, and completes the transaction and finishes payment request procedures with respect to a corresponding bank after generating the payment information.

7. The TV shopping system as claimed in claim 3, wherein
the data processing and transaction unit further has a point of sale device electrically connected with the microprocessor to read a card for payment and generate and transmit the payment information to the microprocessor, and
the shopping service platform is linked with servers of a credit card center and banks for secure transactions, and completes the transaction and finishes payment request procedures with respect to a corresponding bank after generating the payment information.

8. The TV shopping system as claimed in claim 4, wherein
the data processing and transaction unit further has a point of sale device electrically connected with the microprocessor to read a card for payment and generate and transmit the payment information to the microprocessor, and
the shopping service platform is linked with servers of a credit card center and banks for secure transactions, and completes the transaction and finishes payment request procedures with respect to a corresponding bank after generating the payment information.

9. The TV shopping system as claimed in claim 5, wherein the shopping service platform generates the payment information after receiving information associated with a credit card number from the remote control unit, and completes the transaction and finishes payment request procedures with respect to a corresponding bank.

10. The TV shopping system as claimed in claim 6, wherein the shopping service platform generates the payment information after receiving information associated with a credit card number from the remote control unit, and completes the transaction and finishes payment request procedures with respect to a corresponding bank.

11. The TV shopping system as claimed in claim 7, wherein the shopping service platform generates the payment information after receiving information associated with a credit card number from the remote control unit, and completes the transaction and finishes payment request procedures with respect to a corresponding bank.

12. The TV shopping system as claimed in claim 8, wherein the shopping service platform generates the payment information after receiving information associated with a credit card number from the remote control unit, and completes the transaction and finishes payment request procedures with respect to a corresponding bank.

13. The TV shopping system as claimed in claim 1, wherein the shopping service platform is linked with servers of a credit card center and banks for secure transactions, generates the payment information after receiving information associated with a credit card number from the remote control unit, and completes the transaction and finishes payment request procedures with respect to a corresponding bank.

14. The TV shopping system as claimed in claim 2, wherein the shopping service platform is linked with servers of a credit card center and banks for secure transactions, generates the payment information after receiving information associated with a credit card number from the remote control unit, and completes the transaction and finishes payment request procedures with respect to a corresponding bank.

15. The TV shopping system as claimed in claim 3, wherein the shopping service platform is linked with servers of a credit card center and banks for secure transactions, generates the payment information after receiving information associated with a credit card number from the remote control unit, and completes the transaction and finishes payment request procedures with respect to a corresponding bank.

16. The TV shopping system as claimed in claim 4, wherein the shopping service platform is linked with servers of a credit card center and banks for secure transactions, generates the payment information after receiving information associated with a credit card number from the remote control unit, and completes the transaction and finishes payment request procedures with respect to a corresponding bank.

17. The TV shopping system as claimed in claim 9, wherein the network device is a computer.

18. The TV shopping system as claimed in claim 10, wherein the network device is a computer.

19. The TV shopping system as claimed in claim 11, wherein the network device is a computer.

20. The TV shopping system as claimed in claim 12, wherein the network device is a computer.

21. The TV shopping system as claimed in claim 13, wherein the network device is a computer.

22. The TV shopping system as claimed in claim 14, wherein the network device is a computer.

23. The TV shopping system as claimed in claim 15, wherein the network device is a computer.

24. The TV shopping system as claimed in claim 16, wherein the network device is a computer.

26. The TV shopping system as claimed in claim 1, wherein the network device is a computer.

27. The TV shopping system as claimed in claim 2, wherein the network device is a computer.

28. The TV shopping system as claimed in claim 3, wherein the network device is a computer.

29. The TV shopping system as claimed in claim 4, wherein the network device is a computer.

30. A TV shopping method, comprising steps of:
providing a shopping service platform having:
a channel information mapping table having existing cable TV channels, cable TV operators and channel numbers respectively corresponding to the cable TV channels of the cable TV operators; and
a plurality of program lists, each associated with each cable TV channel;
an information download processing step; and
a transaction request processing step;
providing a network device connected with the shopping service platform through the Internet to transmit an information download request to the shopping service platform and receiving channel information and consumption information corresponding to the information download request; and
providing TV remote control linked with the network device, remotely controlling a television and providing a step of downloading merchandise information on a real-time basis and a step of purchasing merchandise associated with a TV commercial;
wherein when performing the step of downloading merchandise information on a real-time basis, the TV remote control transmits the information download request to the shopping service platform to activate the information download processing step of the shopping service platform, and transmits the channel information mapping table, the program list associated with each cable TV channel, and consumption information associated with merchandise of TV commercials of each cable TV channel to the TV remote control through the network device, and
when performing a step of purchasing merchandise associated with a TV commercial, the TV remote control transmits shopping information to the shopping service platform to activate the transaction request processing step of the shopping service platform to place an order to a corresponding merchandise vendor and transmit a delivery completion notice to the TV remote control through the network device after completion of the delivery.

31. The TV shopping method as claimed in claim 30, wherein the information download processing step executed by the shopping service platform comprises steps of:
establishing the channel information mapping table;
receiving and updating channel program information, wherein the shopping service platform acquires a program list in a period of time of each cable TV channel via the Internet;
generating the channel information and the consumption information in accordance with the received channel program information and the channel information mapping table, wherein the channel information has a channel classification list for each cable TV operator and a plurality of channel options; each channel option has a plurality of play items, and each play item has program related information; and
receiving an information download request, wherein after establishing a link with the network device, the shopping service platform transmits the channel information and the consumption information to the network device in accordance with the download request transmitted from the network device.

32. The TV shopping method as claimed in claim 31, wherein the transaction request processing step executed by the shopping service platform comprises steps of:
receiving the shopping information, wherein the shopping service platform receives the shopping information transmitted from the network device through the Internet, and the shopping information has merchandise information and payment information;
authenticating the payment information, wherein the shopping service platform transmits the payment information through the Internet to the credit card center to ask for an authorization code;
transmitting a notice of delivery, wherein after receiving the authorization code sent from the credit card center through the Internet, the shopping service platform generates delivery information, a reply of accepted use of credit card and a payment notice, and sends the delivery information to a vendor to inform the vendor to deliver, the reply of accepted use of credit card to the network device and the payment notice to a corresponding bank to remit payment through the bank; and
responding a delivery completion notice, wherein after receiving the delivery completion notice from the vendor through the Internet, the shopping service platform transmits the delivery completion notice to the network device.

33. The TV shopping method as claimed in claim 32, wherein the step of purchasing merchandise associated with a TV commercial executed by the TV remote control comprises steps of:
generating the consumption information, after receiving a transaction request, the TV remote control generates corresponding merchandise information and displays a screen for selecting a type of payment;
generating payment information, wherein after receiving the type of payment, the TV remote control generates the payment information;
generating the shopping information; after receiving the payment information, the TV remote control integrates the merchandise information and the payment information into the shopping information and transmits the shopping information to the network device; and
receiving the delivery completion notice, wherein the TV remote control receives the delivery completion notice transmitted from the network device.

34. The TV shopping method as claimed in claim 30, wherein the step of purchasing merchandise associated with a TV commercial executed by the TV remote control comprises steps of:
generating the consumption information, after receiving a transaction request, the TV remote control generates corresponding merchandise information and displays a screen for selecting a type of payment;
generating payment information, wherein after receiving the type of payment, the TV remote control generates the payment information;
generating the shopping information; after receiving the payment information, the TV remote control integrates the merchandise information and the payment information into the shopping information and transmits the shopping information to the network device; and
receiving the delivery completion notice, wherein the TV remote control receives the delivery completion notice transmitted from the network device.
